(19) United States
(12) Patent Application Publication
(10) Pub. No.: US 2024/0320497 A1
(43) Pub. Date: Sep. 26, 2024

(54) SYSTEM AND METHOD FOR OPTIMIZED NEURAL ARCHITECTURE SEARCH

(71) Applicant: WOVEN BY TOYOTA, INC., Tokyo (JP)

(72) Inventor: Koichiro YAMAGUCHI, Tokyo (JP)

(73) Assignee: WOVEN BY TOYOTA, INC., Tokyo (JP)

(21) Appl. No.: 18/126,067

(22) Filed: Mar. 24, 2023

(51) Int. Cl. G06N 3/086

(52) U.S. Cl. CPC G06N 3/086

(57) ABSTRACT

Provided are method, system, and device for performing an optimized neural architecture search (NAS) by using both a gradient-based search and a sampling method on a search space. The method may include obtaining a first search space comprising a plurality of candidate layers for a neural network architecture; performing a gradient-based search in the first search space to obtain a first architecture; performing a sampling method search utilizing the first architecture as an initial sample; and obtaining a second architecture as an output of the sampling method search.

### TECHNICAL FIELD

Systems and methods consistent with example embodiments of the present disclosure relate to neural networks, and more particularly, to systems and methods for performing a neural architecture search (NAS).

### BACKGROUND

In the related art, a neural network may generally be characterized by two main parameters: (1) its architecture; and (2) the weights applied to inputs transmitted between neurons. Typically, the architecture is manually or hand-designed by a user, while the weights are optimized by training the network with a training set and neural network algorithm. Thus, to optimize performance of the neural network, the architecture design is an important consideration, particularly as it is generally static once the neural network is deployed for use. FIG. 1 illustrates an example of a neural network architecture in the related art.

Referring to FIG. 1, the example neural network architecture in the related art may be defined by its connections, layer types (or operations), number of layers, and the number of channels in each layer. The layer types may include, for example, convolutional (in the case of a convolutional neural network (CNN)), activation (e.g., rectified linear unit (ReLU)), pooling, fully connected, batch normalization, dropout, etc. The architectural design of a network is embodied by a combination of layers corresponding to at least some of these layer types.

In the related art, neural architecture search (NAS) is a technique for automatically designing the architecture of a neural network. Related art methods for performing NAS may include a sampling method and a gradient-based search method.

FIG. 2 is a functional block diagram of a sampling method according to the related art. Referring to FIG. 2, the sampling method is an iterative process by which a controller generates a sample architecture candidate (e.g., from a search space of a set of layers). The sample architecture is optimized via training and evaluated to obtain metric values (e.g., accuracy, latency, model size, etc.). Based on the evaluation results of the previous sample, the controller then generates a next sample architecture candidate using a method such as reinforcement learning, Bayesian optimization or an evolutionary algorithm. This process is repeatedly performed until a target performance is reached (e.g., until a target accuracy, latency, mode size, etc., is obtained).

FIG. 3 illustrates a gradient-based search method according to the related art. FIG. 3. FIG. 4 illustrates an example super block in the gradient-based search method, and FIG. 5 illustrates an example flow of a gradient-based search method.

Unlike the sampling method, the gradient-based search does not sample architectures, but uses a SuperNet, which is a network of all candidate network architectures. Referring to FIG. 3, the gradient-based search searches for a neural network architecture via a single training process of plural connected super blocks, with each super block corresponding to one layer (and/or one set of layers) and including many choices of candidate layers (and/or sets of layers). For example, Choice 1 may be a 3×3 CNN, Choice 2 may be a 5×5 CNN, Choice 3 may be a max pooling or residual block, etc. In the gradient-based search, the best layer is searched for and selected in each super block. As shown in FIGS. 4 and 5, each candidate has a Θ value (or architecture parameter), which is updated via the training process. That is, if a candidate is determined to have contributed significantly to reducing loss, its Θ value (representing the importance of the candidate layer) is increased through back propagation, and vice-versa. After the architecture parameter Θ is updated in an iteration of the gradient search, weight parameters are updated using training images (e.g., image of a car). The process is repeated until some level of network stability is reached (i.e., some latency or loss is reached) or until a predetermined number of iterations has been completed. Once the training is complete, the best layer (i.e., layer having highest Θ value) is selected for each super block in order to generate the final (optimal) network architecture.

While the sampling method illustrated in FIG. 2 may be flexible in terms of network structures (i.e., in terms of layer types, number of channels, number of layers, macro architecture, etc.) and may provide a trained model with a known performance (i.e., no need for re-training), the process is extremely time-consuming and sensitive to the initial state (i.e., the initial sample architecture) due to its iterative nature. That is, if the initial seed or sample architecture is suboptimal or poor, then more iterations (mutations) and time is required to eventually obtain an optimal architecture.

Meanwhile, the gradient search can provide a reasonably good model in a single process, thereby requiring much less time than the sampling method. However, the gradient search has some constraints with respect to network structure. That is, unlike the sampling method in which the architecture blocks (layer types, number of layers, number of channels, etc.) are highly flexible, the gradient search is constrained to a predefined SuperNet. Further, the gradient search consumes a large amount of memory due to the number of candidate blocks propagated across plural super blocks, thereby limiting the size of the search space (i.e., the SuperNet). That is, the larger the search space, the larger the number of candidate blocks, and the larger the amount of memory to perform the gradient search. Accordingly, the availability of hardware (memory) resources constrains the search space for a gradient search.

Accordingly, there is a need for a more optimized method of NAS which can reduce the overall resource consumption while being able to obtain the optimal architecture in a relatively short period of time.

### SUMMARY

According to embodiments, methods, systems and devices are provided for performing an optimized neural architecture search (NAS) by using both a gradient-based search and a sampling method on a search space. Particularly, a plurality of gradient-based searches may be performed on a plurality of sub-spaces, thereby distributing the hardware requirements for the gradient-based searched while allowing for the SuperNet to be expanded. Further, by utilizing gradient-based searches in the first stage, the initial seeds for the sampling method may be optimized thereby accelerating the search and reducing the amount of time required to find the optimal neural network architecture. Further still, by following the gradient-based search with the sampling method, an unlimited (or delimited) search space may be used to construct the optimal architecture, thereby increasing flexibility of the neural network structure.

According to an embodiment, a method for performing a neural architecture search (NAS) may be provided. The method may include: obtaining a first search space comprising a plurality of candidate layers for a neural network architecture; performing a gradient-based search in the first search space to obtain a first architecture; performing a sampling method search utilizing the first architecture as an initial sample; and obtaining a second architecture as an output of the sampling method search.

Obtaining the first search space may include obtaining a plurality of sub-spaces, including the first search space, each of the plurality of sub-spaces comprising a set of candidate layers; and the performing the gradient-based search comprises performing a plurality of gradient-based searches respectively in the plurality of sub-spaces to obtain a plurality of first architectures.

Performing the sampling method search may include performing the sampling method search utilizing the plurality of first architectures as initial seeds.

The sampling method search may include an evolutionary search algorithm.

The evolutionary search algorithm may include a search space which is a union of the plurality of sub-spaces.

The evolutionary search algorithm may be repeated over a number of iterations.

The number of iterations may be based on a predetermined threshold.

According to embodiments, an apparatus for performing a neural architecture search (NAS) may be provided. The apparatus may include: at least one memory storing computer-executable instructions; and at least one processor configured to execute the computer-executable instructions to: obtain a first search space comprising a plurality of candidate layers for a neural network architecture; perform a gradient-based search in the first search space to obtain a first architecture; perform a sampling method search utilizing the first architecture as an initial sample; and obtain a second architecture as an output of the sampling method search.

The at least one processor may be further configured to execute the computer-executable instructions to obtain the first search space by obtaining a plurality of sub-spaces, including the first search space, each of the plurality of sub-spaces comprising a set of candidate layers; and wherein the at least one processor may be further configured to execute the computer-executable instructions to perform the gradient-based search by performing a plurality of gradient-based searches respectively in the plurality of sub-spaces to obtain a plurality of first architectures.

The at least one processor may be further configured to execute the computer-executable instructions to perform the sampling method search by performing the sampling method search utilizing the plurality of first architectures as initial seeds.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates an example neural network architecture according to the related art.

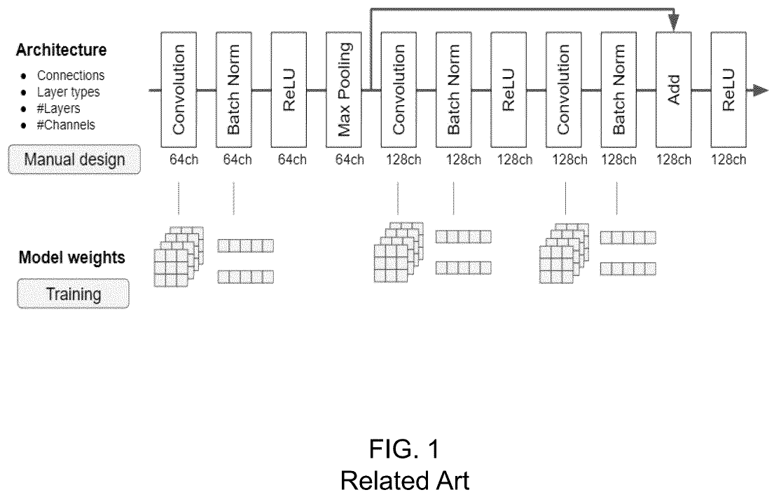

FIG. 2 illustrates a functional block diagram of a sampling method according to the related art;

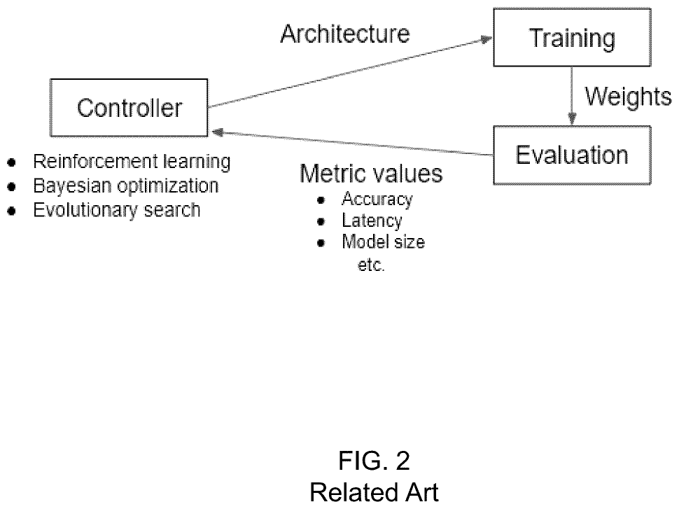

FIG. 3 illustrates a functional block diagram of a gradient-based search method according to the related art;

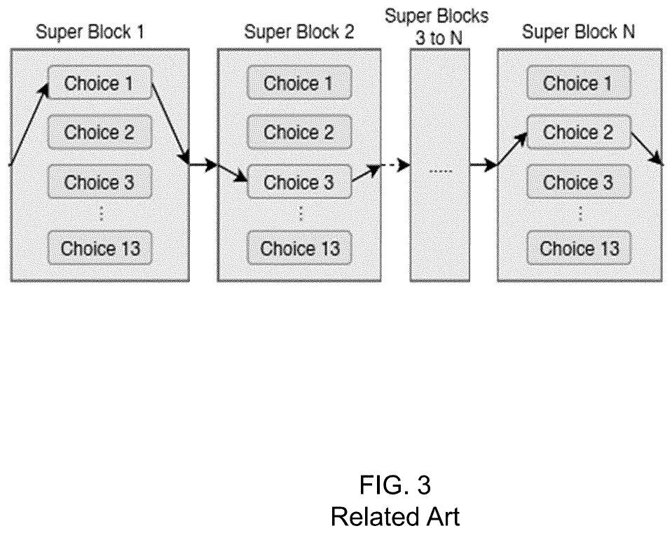

FIG. 4 illustrates an example super block in a gradient-based search method according to the related art;

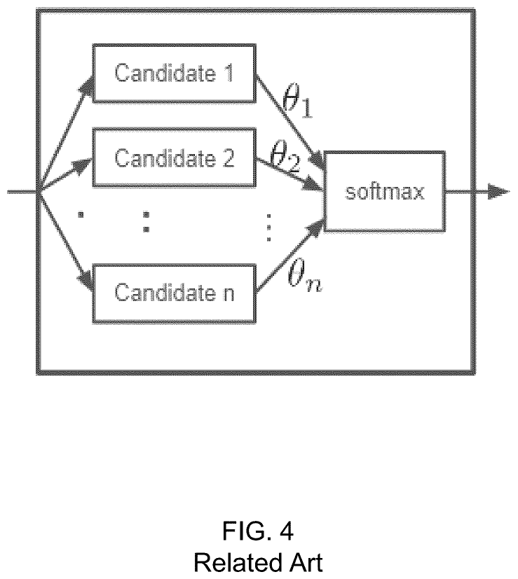

FIG. 5 illustrates a flow diagram of a gradient-based search method according to the related art;

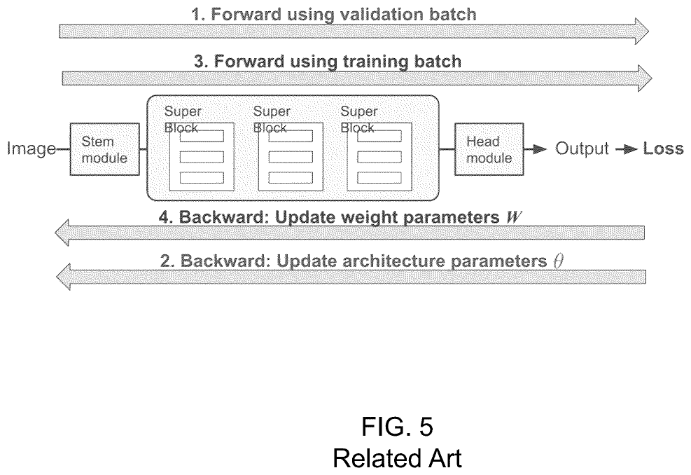

FIG. 6 illustrates a functional block diagram of a neural architecture search (NAS) process, according to one or more embodiments; and

FIG. 7 illustrates a flow diagram of an example method for performing an optimized NAS process, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Examples embodiments of the present disclosure provides a method and a system for performing an optimized neural architecture search (NAS) by using both a gradient-based search and a sampling method on a search space. According to example embodiments, a plurality of gradient-based searches may be performed on a plurality of sub-spaces, thereby distributing the hardware requirements for the gradient-based searched while allowing for the SuperNet to be expanded. Further, by utilizing gradient-based searches in the first stage, the initial seeds for the sampling method may be optimized thereby accelerating the search and reducing the amount of time required to find the optimal neural network architecture. Also, by following the gradient-based search with the sampling method, an unlimited (or delimited) search space may be used to construct the optimal architecture, thereby increasing flexibility of the network structure.

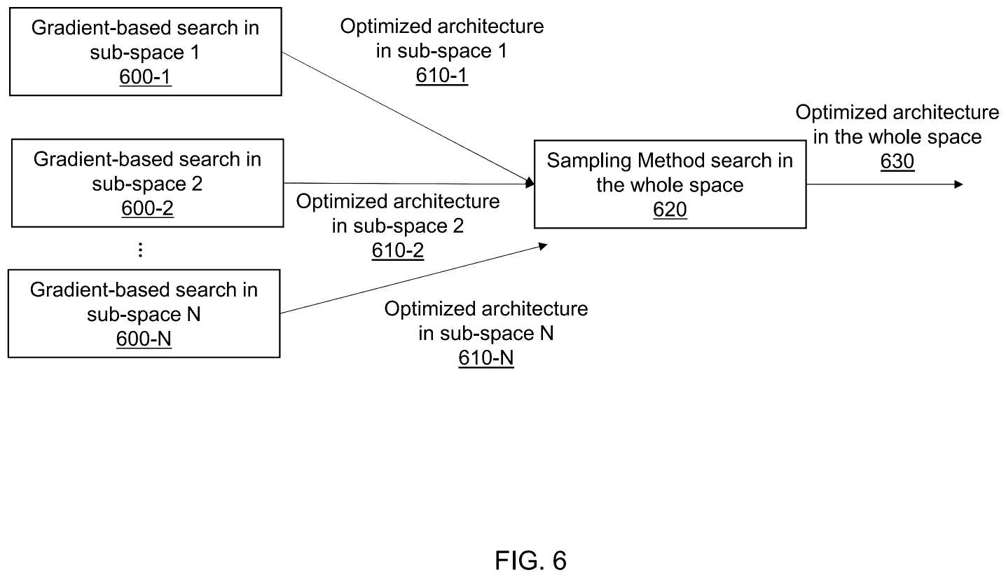

FIG. 6 illustrates a functional block diagram of a neural architecture search (NAS) process. Referring to FIG. 6, the optimized NAS in accordance with an example embodiment first independently performs a plurality of gradient-based searches respectively on a plurality of sub-spaces (i.e., sub-spaces of a SuperNet). As illustrated in FIG. 6, gradient-based search 600-1 may be performed in sub-space 1, gradient-based search 600-2 may be performed in sub-space 2, and gradient-based search 600-N may be performed in sub-space N, where N is any number of sub-spaces. The plurality of sub-spaces (sub-space 1, sub-space 2, . . . sub-space N) includes different sets of candidate blocks. It should be appreciated that the different sets used for the sub-spaces may or may not include overlap therebetween.

The plurality of gradient-based searches output a plurality of optimized architectures, i.e., each gradient-based search outputs an optimized architecture. Referring to FIG. 6, performing gradient-based search 600-1 in sub-space 1 will result in the optimized architecture 610-1 for sub-space 1 being obtained, and similarly with gradient-based search 600-2 in sub-space 2 resulting in optimized architecture 610-2 for sub-space 2, and gradient-based search 600-N in sub-space N resulting in optimized architecture 610-N for sub-space N.

According to various embodiments, the plurality of gradient-based searches may be performed in parallel (e.g., using different hardware infrastructure or resources (nodes, clusters, servers, data centers, etc.)), sequentially, or with some temporal overlap therebetween. The SuperNet and the sub-spaces may be initialized or configured manually or using a predefined search space (SuperNet) that is divided into the sub-spaces according to a predetermined algorithm or policy or randomly.

The plurality of optimized architectures (610-1, 610-2, . . . 610-N) is used as an initial set of candidate architectures for sampling method 620 across the whole space. According to one embodiment, the plurality of optimized architectures may be used as the initial seeds for an evolutionary search. Nevertheless, it should be noted that the search space which is used in the evolutionary search may be a union of all search sub-spaces used in the gradient search, or could be a larger space which includes sub-spaces that are outside of the gradient search.

The evolutionary search is performed iteratively, and may include using a performance metric or fitness/validation score in order to obtain the optimized architecture 630 in the whole space. According to one embodiment, in each iteration of the evolutionary search, the candidate architectures are mutated (e.g., modifying a 5×5 convolution layer to a 3×3 convolution layer) utilizing the entire search space (e.g., any possible layer, layer type, number of channels, number of layers), trained (e.g., for a few epochs), and evaluated. Then, the lowest scoring architectures in the candidate pool are replaced with new (mutated) architectures that are determined to perform better. This is repeated over several iterations until a predetermined number of iterations have been performed or until some predetermined threshold is reached (e.g., predetermined optimal performance) and an optimized architecture 630 in the whole space is output. Nevertheless, it should be appreciated that several possible criteria may be used for the threshold to select optimized architecture 630. While the simplest method would be to select the architecture with the highest score, if multiple metrics are being considered (e.g., accuracy and latency (runtime speed)), one example process would be to output all architectures of a Pareto-front set. Another possible method would be to use crossover during the evolutionary search process. Specifically, a low-scored architecture can be replaced with a crossover of two higher-scored architectures.

While the present embodiments described above utilize an evolutionary search, it is understood that one or more other embodiments are not limited thereto. In another embodiment, another sampling method or algorithm may be utilized (e.g., reinforcement learning). Further, a single search space may be selected from the plurality of optimized architectures output by the gradient searches as an initial seed for the sampling method. For example, a search space with a highest evaluation of validation score (or a highest particular metric, e.g., latency, model size, etc.) may be selected, or a search space may be randomly selected from among the plural optimized architectures output by the gradient search. Furthermore, the search space which

Moreover, while the present embodiments described above performs a plurality of gradient searches in a plurality of sub-spaces, it is understood that one or more other embodiments are not limited thereto. For example, according to another embodiment, a single gradient-based search may be performed on a sub-space or on the SuperNet, with the output thereof used as an initial seed to run the sampling method.

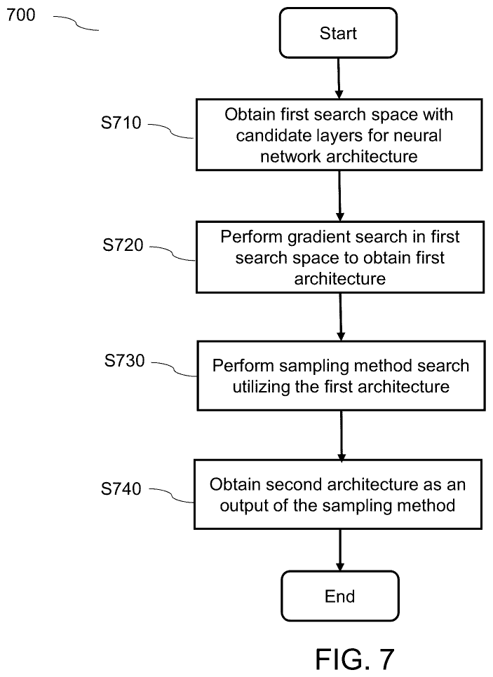

FIG. 7 illustrates a flow diagram of an example method 700 for performing an optimized NAS process. Referring to FIG. 7, at operation S710, a first search space with candidate layers for a neural network architecture is obtained. According to one embodiment, obtaining the first search space may include obtaining a plurality of sub-spaces (i.e., sub-spaces 1, 2, . . . . N as described with reference to FIG. 6 above), and each sub-space may include a set of candidate layers.

At operation S720, a gradient-based search may be performed in the first search space obtained in operation S710 in order to output a first architecture. It should be appreciated that in some embodiments, a plurality of gradient-based search may be performed in order to output a plurality of architectures. This may be similar to gradient-based searches 600-1, 600-2, . . . 600-N described with reference to FIG. 6 above in order to output the plurality of architectures 610-1, 610-2, . . . 610-N.

At operation S730, a sampling method may be performed by utilizing the first architecture outputted in operation S720 as an initial sample. According to one embodiment, the sampling method may be similar to sampling method 620 described with reference to FIG. 6 above. According to one embodiment, the sampling method may be an evolutionary search algorithm. The evolutionary search algorithm may utilize a search space which is a union of the plurality of sub-spaces. The evolutionary search algorithm may be repeated over a number of iterations, and this number of iterations may be based on a predetermined threshold.

At operation S740, the second architecture may be output as a result of the sampling method performed in operation S730. The second architecture may be similar to architecture 630 described with reference to FIG. 6 above. It should also be appreciated that while the present embodiment describes outputting a second architecture, some embodiments may output a plurality of architectures.

In view of the above, examples embodiments of the present disclosure provides a method and a system for performing an optimized neural architecture search (NAS) by using both a gradient-based search and a sampling method on a search space. According to example embodiments, a plurality of gradient-based searches may be performed on a plurality of sub-spaces, thereby distributing the hardware requirements for the gradient-based searched while allowing for the SuperNet to be expanded. Further, by utilizing gradient-based searches in the first stage, the initial seeds for the sampling method may be optimized thereby accelerating the search and reducing the amount of time required to find the optimal neural network architecture. Also, by following the gradient-based search with the sampling method, an unlimited (or delimited) search space may be used to construct the optimal architecture, thereby increasing flexibility of the network structure.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for performing a neural architecture search (NAS), the method comprising;
obtaining a first search space comprising a plurality of candidate layers for a neural network architecture;
performing a gradient-based search in the first search space to obtain a first architecture;
performing a sampling method search utilizing the first architecture as an initial sample; and
obtaining a second architecture as an output of the sampling method search.

2. The method according to claim 1, wherein the obtaining the first search space comprises obtaining a plurality of sub-spaces, including the first search space, each of the plurality of sub-spaces comprising a set of candidate layers; and the performing the gradient-based search comprises performing a plurality of gradient-based searches respectively in the plurality of sub-spaces to obtain a plurality of first architectures.

3. The method according to claim 2, wherein the performing the sampling method search comprises performing the sampling method search utilizing the plurality of first architectures as initial seeds.

4. The method according to claim 3, wherein the sampling method search comprises an evolutionary search algorithm.

5. The method according to claim 4, wherein the evolutionary search algorithm utilizes a search space which is a union of the plurality of sub-spaces.

6. The method according to claim 4, wherein the evolutionary search algorithm is repeated over a number of iterations.

7. The method according to claim 6, wherein the number of iterations is based on a predetermined threshold.

8. An apparatus for performing a neural architecture search (NAS), the apparatus comprising:
at least one memory storing computer-executable instructions; and
at least one processor configured to execute the computer-executable instructions to:
obtain a first search space comprising a plurality of candidate layers for a neural network architecture;
perform a gradient-based search in the first search space to obtain a first architecture;
perform a sampling method search utilizing the first architecture as an initial sample; and
obtain a second architecture as an output of the sampling method search.

9. The apparatus according to claim 8, wherein the at least one processor is further configured to execute the computer-executable instructions to obtain the first search space by obtaining a plurality of sub-spaces, including the first search space, each of the plurality of sub-spaces comprising a set of candidate layers; and wherein the at least one processor is further configured to execute the computer-executable instructions to perform the gradient-based search by performing a plurality of gradient-based searches respectively in the plurality of sub-spaces to obtain a plurality of first architectures.

10. The apparatus according to claim 9, wherein the at least one processor is further configured to execute the computer-executable instructions to perform the sampling method search by performing the sampling method search utilizing the plurality of first architectures as initial seeds.

11. The apparatus according to claim 10, wherein the sampling method search comprises an evolutionary search algorithm.

12. The apparatus according to claim 11, wherein the evolutionary search algorithm utilizes a search space which is a union of the plurality of sub-spaces.

13. The apparatus according to claim 11, wherein the evolutionary search algorithm is repeated over a number of iterations.

14. The apparatus according to claim 13, wherein the number of iterations is based on a predetermined threshold.

15. A non-transitory computer-readable recording medium having recorded thereon instructions executable by at least one processor to cause the at least one processor to perform a method comprising:
obtaining a first search space comprising a plurality of candidate layers for a neural network architecture;
performing a gradient-based search in the first search space to obtain a first architecture;
performing a sampling method search utilizing the first architecture as an initial sample; and
obtaining a second architecture as an output of the sampling method search.

16. The non-transitory computer-readable recording medium according to claim 15, wherein the obtaining the first search space comprises obtaining a plurality of sub-spaces, including the first search space, each of the plurality of sub-spaces comprising a set of candidate layers; and the performing the gradient-based search comprises performing a plurality of gradient-based searches respectively in the plurality of sub-spaces to obtain a plurality of first architectures.

17. The non-transitory computer-readable recording medium according to claim 16, wherein the performing the sampling method search comprises performing the sampling method search utilizing the plurality of first architectures as initial seeds.

18. The non-transitory computer-readable recording medium according to claim 17, wherein the sampling method search comprises an evolutionary search algorithm.

19. The non-transitory computer-readable recording medium according to claim 18, wherein the evolutionary search algorithm utilizes a search space which is a union of the plurality of sub-spaces.

20. The non-transitory computer-readable recording medium according to claim 18, wherein the evolutionary search algorithm is repeated over a number of iterations.
